(19) United States
(12) Patent Application Publication
(10) Pub. No.: US 2003/0123677 A1
(43) Pub. Date: Jul. 3, 2003

(54) Stereonet device

(76) Inventor: Dong Hai Tran, San Francisco, CA (US)

Correspondence Address: Dong Hai Tran, 7146 Mission Street, Daly City, CA, 94014, US

(21) Appl. No.: 10/040,212

(22) Filed: Jan. 3, 2002

(51) Int. Cl. H04B 3/00

(52) U.S. Cl. 381/81

(57) ABSTRACT

The Stereonet Device is a switching device that contains two stages of a switching circuit. This device is for the user to input another source of an audio signal and a voice pick-up microphone audio signal to their stereo system. The users of this invention are mostly automobile drivers or passengers. This device will work with almost every stereo system in the market today. It may become a crucial stereo adapter and an important feature for future automobile stereo systems.

The other source of audio signals mentioned above can be car in-dash CD players, cassette players, CD changers, portable cassette players, portable CD players, MP3 players, notebook computers, cellular phones, or any other audio signal source.

The voice pick-up microphone audio signal mentioned above is a microphone on a clipper that can be clamped to the cellular phone to pick up the voice sound and convert it to audio signal input to the Stereonet Device. With the cellular phone placed in the holder, the driver has his hands free while talking on the cell phone and listening to the other party through the car stereo system speakers. There are many cellular phones with a voice dialer function in the market currently, allowing car drivers to talk on the phone in the car totally hands free with the Stereonet Device.

The Stereonet Device can connect to the stereo system either before or after the volume control section of the stereo unit. It will input the signal from the pre-amp section of the stereo unit, and output the signal to the power-amp section of the stereo unit. The Stereonet Device only deals with switching analog audio signals. It doesn't generate any RF signals, and thus will not do any harm to any appliance surrounding it.

The Stereonet Device also has an external output to let the user add an external amplifier and/or subwoofer amplifier to their stereo systems.

The Stereonet Device has its own volume control to adjust volume level of the external source input signal and cellular phone volume. This will not mess up the user's stereo system's volume settings, and avoid excessively low or loud audio volume when switched back to the user's stereo system.

### CROSS-REFERENCE TO RELATE APPLICATIONS

The Stereonet Device is my invention, and I did start out from the scratch. It is not a modification from any product or applications. I don't find any product that works or looks like my invention on the market, and I was unable to find any inventions that looks like my invention after going through the patent search of the patent database on the USPTO web site.

There are 3 set of the data sheet of the components that I'm using in this device for reference:

Switching IC MC 14066

Op-amp IC RC 4558

NPN silicon transistor MMBT3904TT1

### FIELD OF THE INVENTION

The present invention is related to the field of an analog audio signal-switching device, and more specifically to using the selectively source of the audio signal by using switching IC circuit.

### BACKGROUND OF THE INVENTION

The present invention named the Stereonet Device provides every stereo the capability of inputting an audio signal from a variety of stereo products. The Stereonet Device is a switching device to let the user input a source of an analog audio signal to their stereo system.

Dong started this invention in 1990 for personal use, which inputs a CD changer and portable CD player signal to his Honda, Nissan, Toyota, and Oldsmobile car stereos. The device was originally built with relays to switch the audio signals. The device has been improved in later years, by replacing relays with switching ICs, to reducing the size of the 1^{st} stage switching P. C. broad so that it can be installed inside the car stereo unit. It has been tested and works well with many brand name car stereos. The unit has a put-in microphone to pick up the voice sound on the cellular phone for safe driving. This improvement is pertinent because several times, Dong, himself, experienced near accidents while talking on the cellular phone and driving his car. The improvement also includes the 2^{nd} stage switching circuit and volume control for selecting signal source and audio volume. After Dong moved to San Francisco in September 1999, he devoted his full effort and time into running his stereo repair service shop in Daly City and completing his invention. During this time, Dong has spoken to many people who have comments on his invention. He found that his invention has market demand. In addition, it will help our nation's economy during this recession period and contribute its benefit to the people as in the following ways:

1. Job employment. Each Stereonet Device needs a skilled service technician to install to the user's/customer's stereo, and each stereo unit needs a stereo installer to take the stereo unit out and put it back in to the user's car. Also, every Stereonet Device needs manufacturers and salespersons.

2. Increase products demand and consumption. The Stereonet Device will connect many varieties of stereo audio products to the user's stereo unit. Many portable stereos can easily fit into a user's budget nowadays. The Stereonet Device also allows the user to add an external amp/subwoofer. That will let consumers increase consuming demand and purchase more consumer products.

3. Driving Safety. The Stereonet Device is hands free talking feature ready. It will let the driver simultaneously talk on the cellular phone and drive safely.

4. Precision audio quality. The Stereonet Device installs directly to user's stereo unit, so it doesn't emit any RF signals or any other mechanical side effects that can cause distortions, yielding consumers the best and most precise audio quality for enjoyment and entertainment and more.

### BRIEF SUMMARY OF THE INVENTION

The present invention provides every stereo the capability of inputting an audio signal from a variety of stereo products. This Device consists of 2 small P. C. Boards.

The first P. C. Board describes the 1^{st} stage switching circuit and its component has several functions as follows: (Please refer to The 2^{nd} sheet of the drawing)

a. The main function of the 1^{st} stage switching circuit is to select the audio signal between the user's stereo signal and an external source stereo signal from the 2^{nd} P. C. Board by switching IC U1 and U2.

b. The Op-amp IC U3 and U4 are the 4 channels pre-amplifier is used to compensate the signal lost of the switching circuits.

c. The other Op-amp IC U5 and U6 are the 4 channels pre-amplifier is for external pre-amp output to allow the user to add a power amplifier. It brings the signal output from the 1^{st} switching circuit to the Standard pre-amp output level.

d. The RCA Cable and jack connector provide a pre-amp signal output connection to the External Amplifier.

e. The mute circuit Q2, Q3, Q4, Q5, D1, R6, R7, C23, and C24 are uses to mute the pop noise when the switch VR1_SW is selected.

f. The ten color-coded wires are used to connect the Stereonet Device to a user's stereo.

g. The Din cable and jack are used to provide a connection between the 1^{st} P. C. Board and the 2^{nd} P. C. Board.

h. The power supplies circuit to convert the +14V to +9V for this device uses.

The second P. C. Board is the 2^{nd} switching circuit and its component has several functions as follows: (Please refer to The 3^{RD} sheet of the drawing)

1. The 3.5 mm stereo jack allows the user to input an external source audio signal from a variety of stereo products.

2. The Op-amp IC U101 uses to balances the input impedance.

3. The clip Microphone picks up the audio voice sounds from the cellular phone.

4. The Op-amp IC U102A and the Potentiometer VR2 balances audio signals between the microphone and the 3.5 mm stereo jack.

5. The Op-amp U102B and C105, C110, C111, C112, R106-R108 is the notch filter uses to prevent echo noise.

6. The Switch S101 and Switching IC select audio signals between the microphone and the 3.5 mm stereo jack.

7. The Volume Control VR1 to adjusts the audio signal level of the Stereonet device.

8. The Switch VR1_SW on the Volume control used to enable the Switching ICs from the 1^{st} stage switching circuit to select the signal between the user's stereo and the Stereonet Device.

9. The mute circuit Q102, Q103, D101, R118, R119, C114, and C115 are uses to mute the pop noise when the switch S1 is selected.

10. The Din Cable and Connector provide a connection between the 2^{nd} P. C. Board and the 1^{st} P. C. Board.

11. The Capacitor C116 prevents signal ground noise when a user connects it to the car in-dash stereo player product.

### BRIEF DESCRIPTION OF THE DRAWINGS

There are 3 drawings for the Stereonet Device.

1. Ihe first of the drawings are the block diagrams to illustrate how the Stereonet Device works.

2. The second sheet of the drawings is the electronic schematics for the 1^{st} P. C. Board, the 1^{st} stage switching circuit, the switching circuit signal lost compensation circuit, the pre-amp output circuit, mute circuit, and its components.

3. The third sheet is the electronic schematics for the 2^{nd} P. C. Board, the 2^{nd} stage switching circuit, external audio input circuit, hand free phone circuit, volume control and its components.

### BRIEF DESCRIPTION OF THE PICTURES

There are 8 Pictures for the Stereonet Device

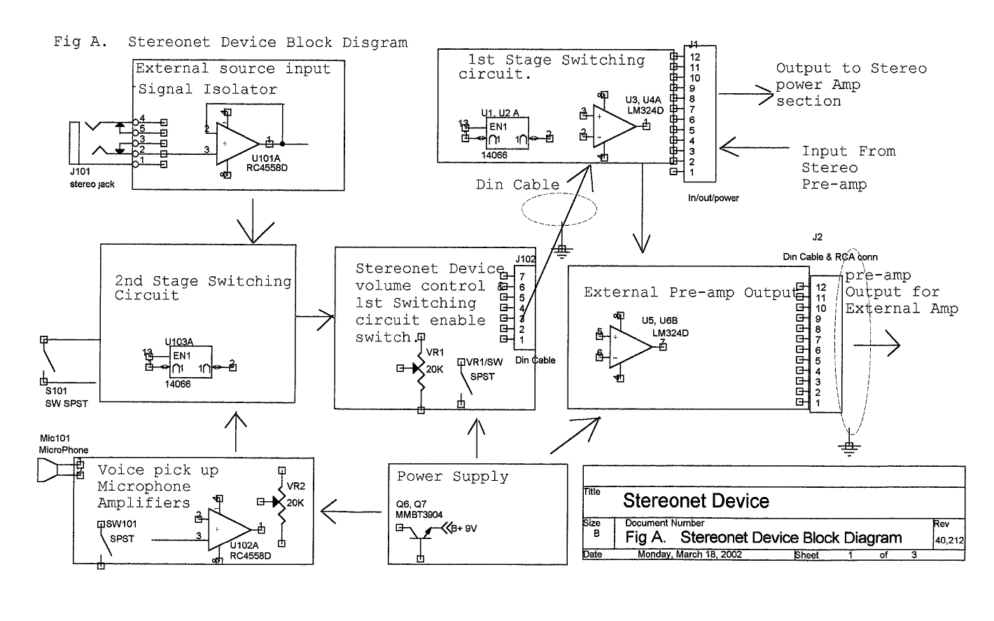

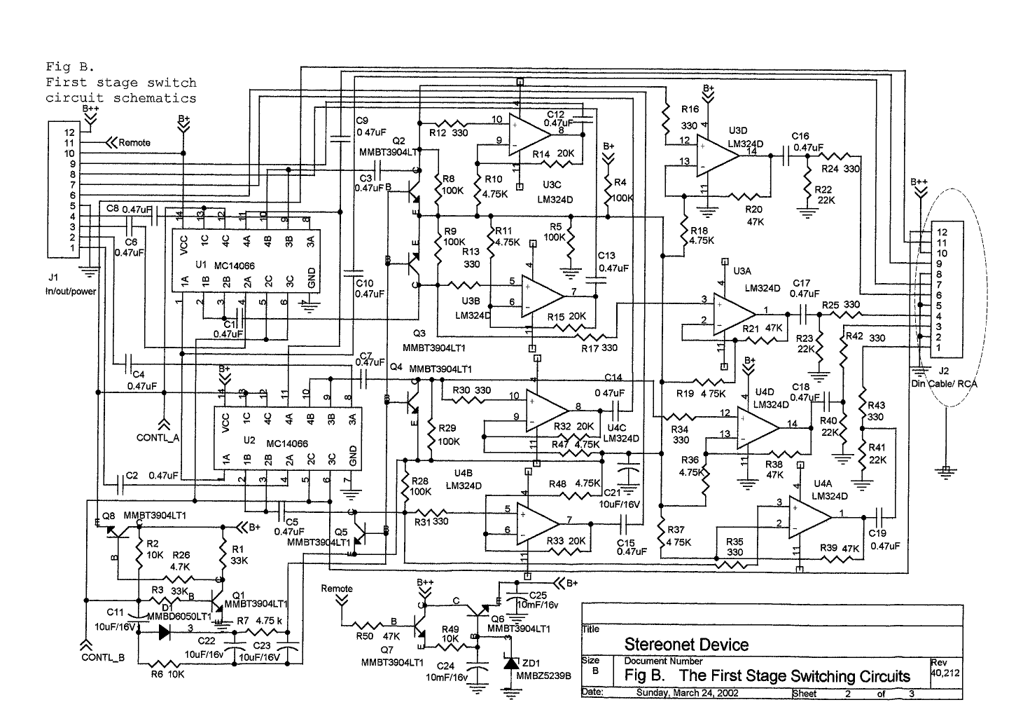

1. FIG. 1, shows the whole Stereonet Device.

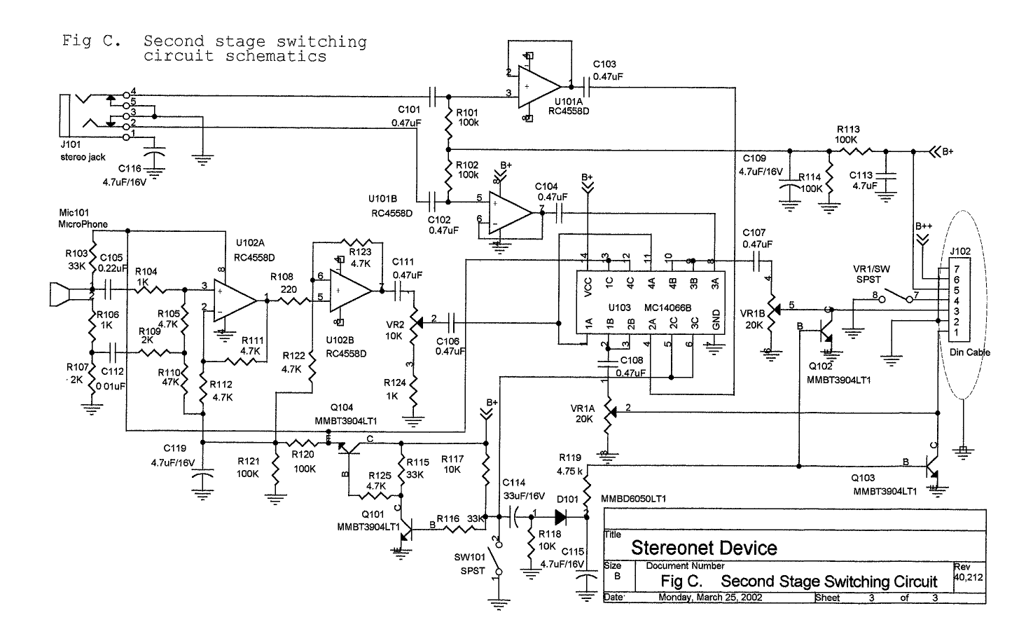

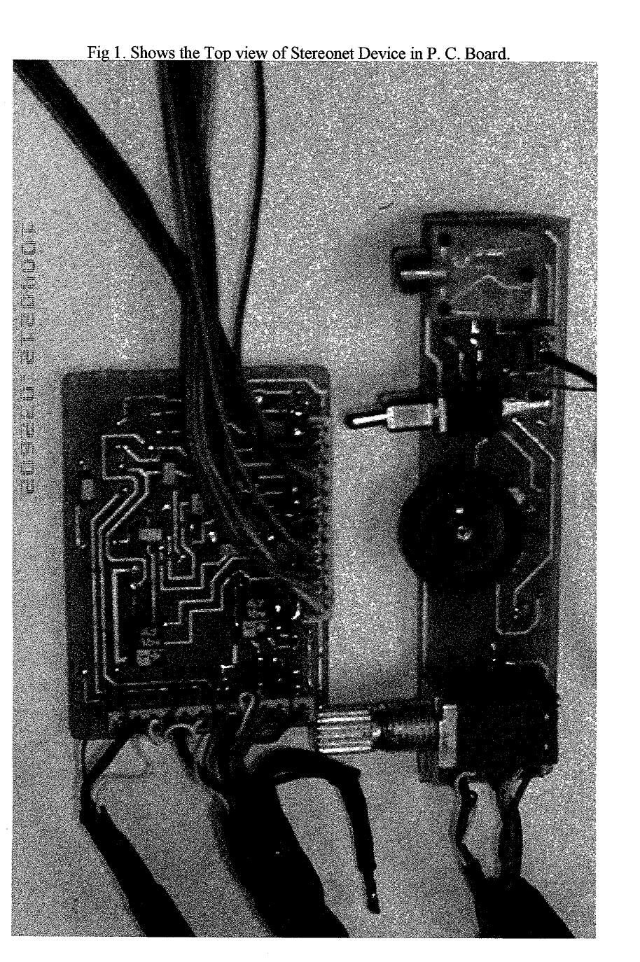

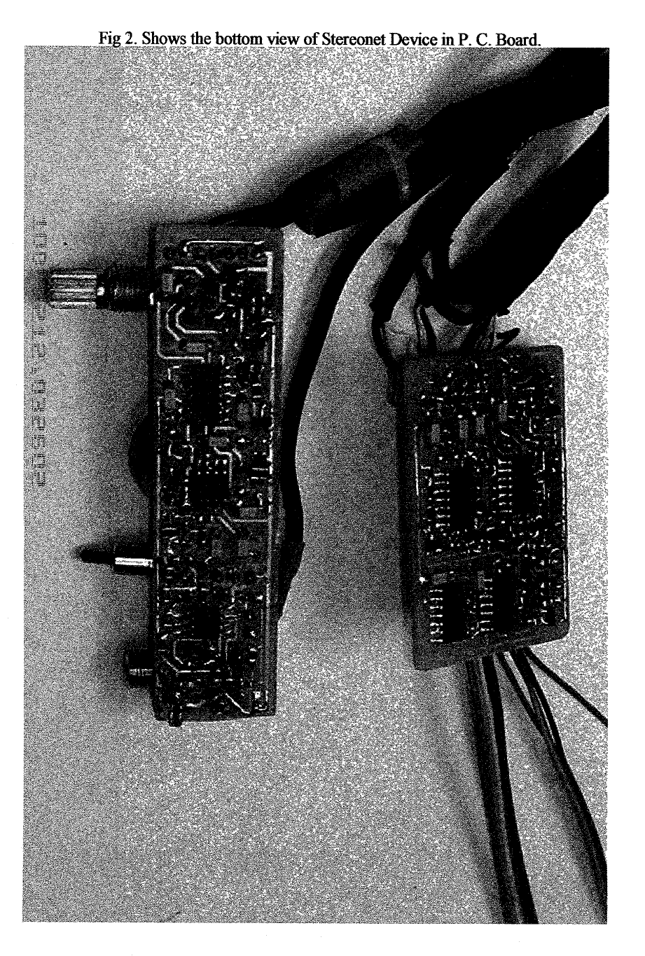

2. FIG. 2, shows the 1^{st} P. C. Board and the 2^{nd} P. C. Board.

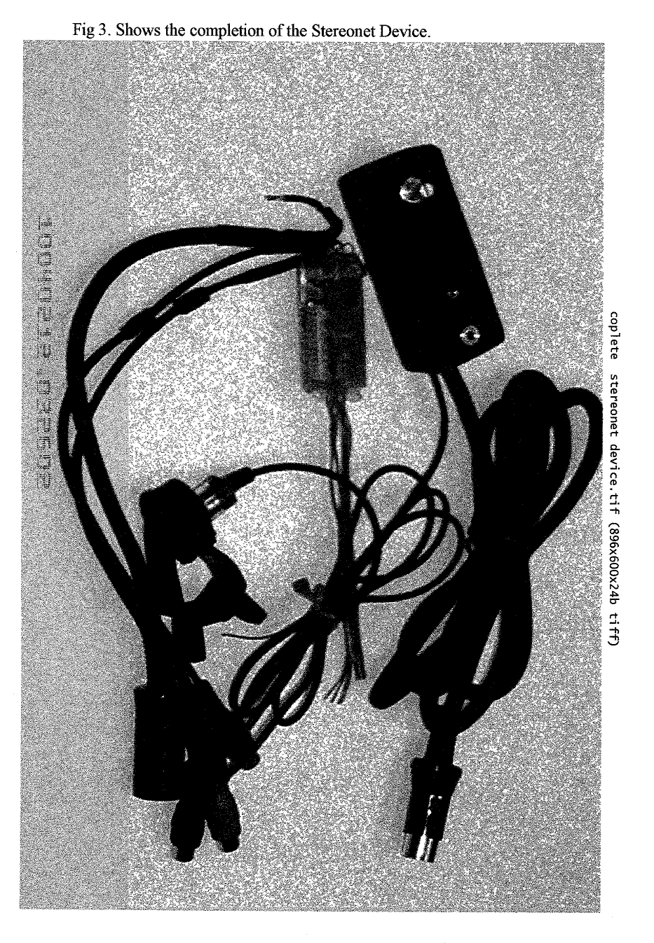

3. FIG. 3, shows the completion of the 1^{st} stage switching circuit.

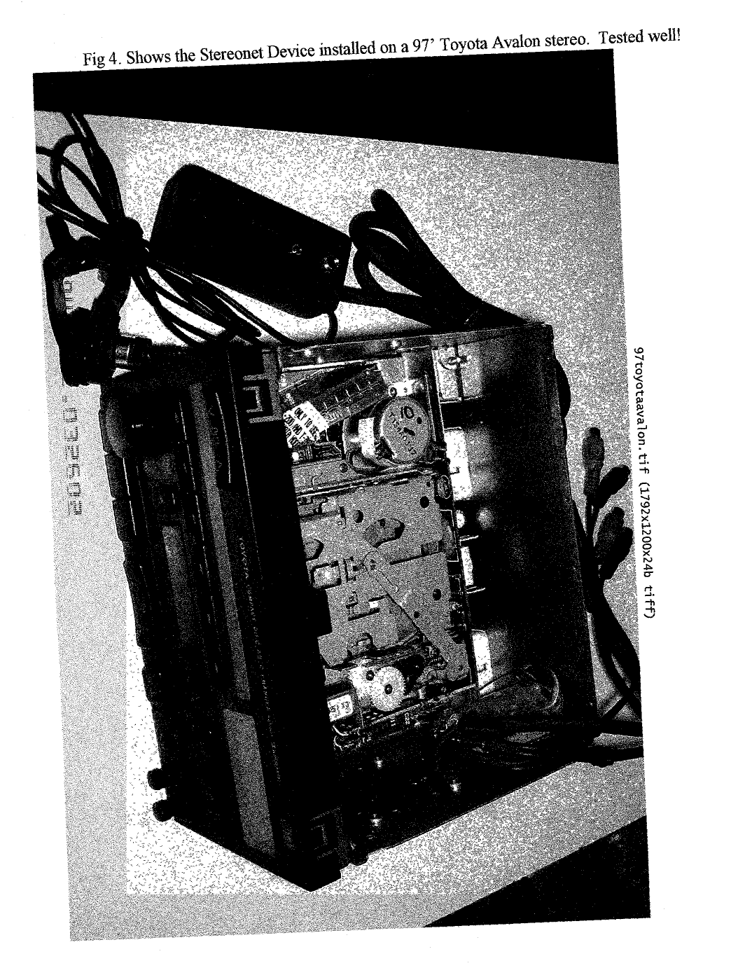

4. FIG. 4, shows the completion of the 2^{nd} stage switching circuit

5. FIG. 5, shows the Stereonet Device installed on a GM Delco Car stereo. Tested and it works great.

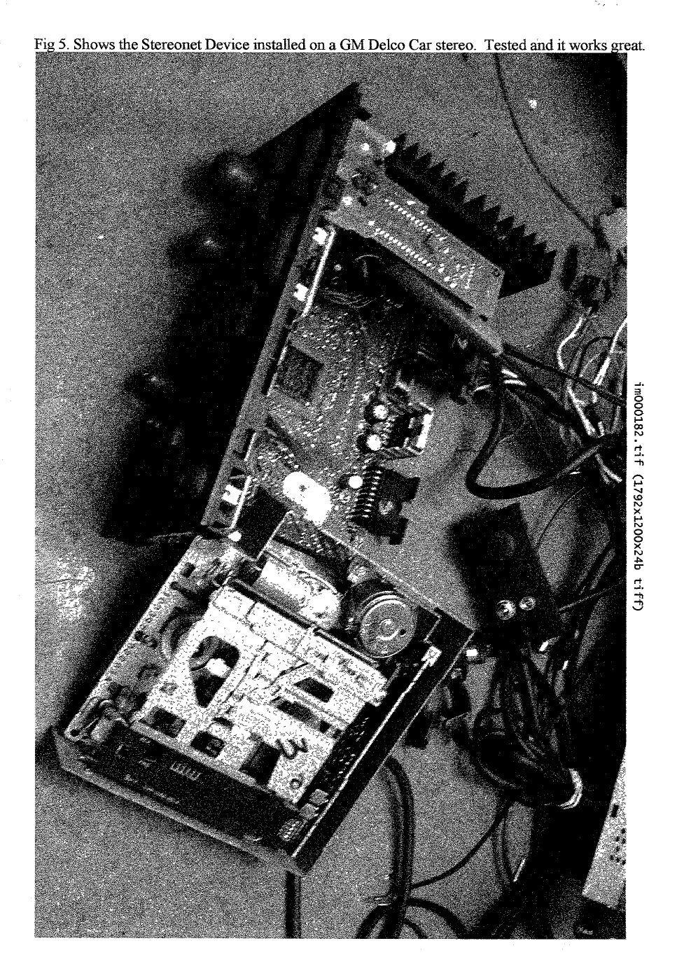

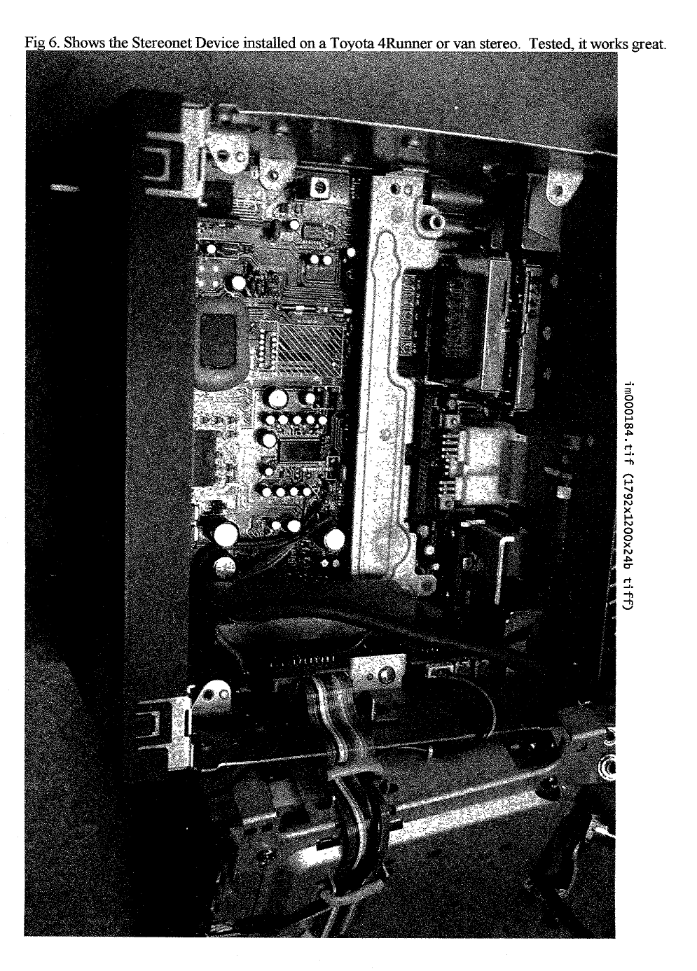

6. FIG. 6, shows the Stereonet Device installed on a Toyota 4Runner or van car stereo. Tested and it works great.

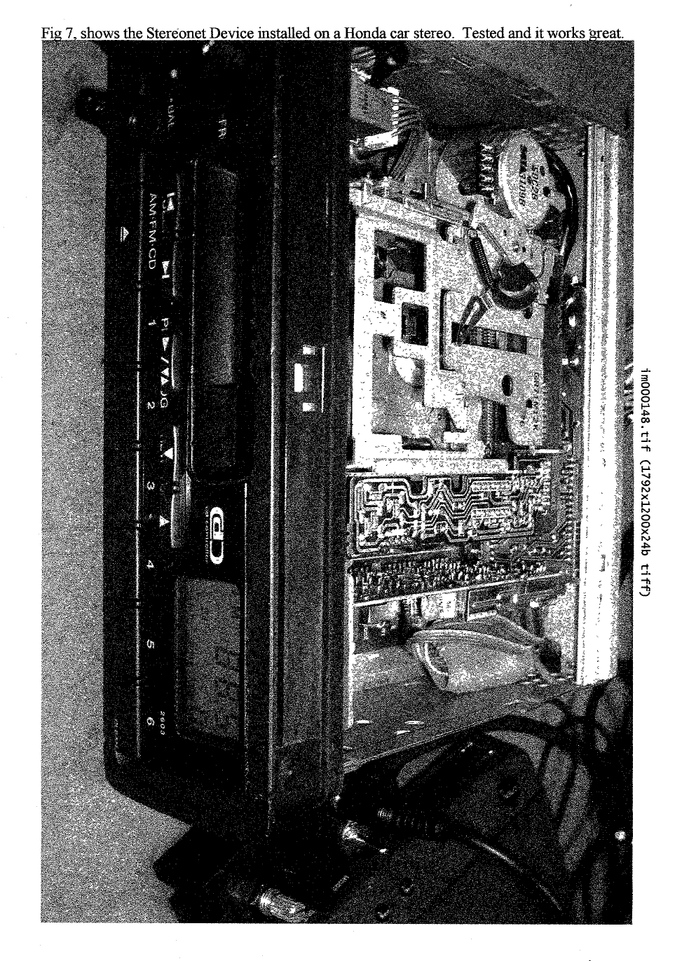

7. FIG. 7, shows the Stereonet Device installed on a Honda car stereo. Tested and it works great.

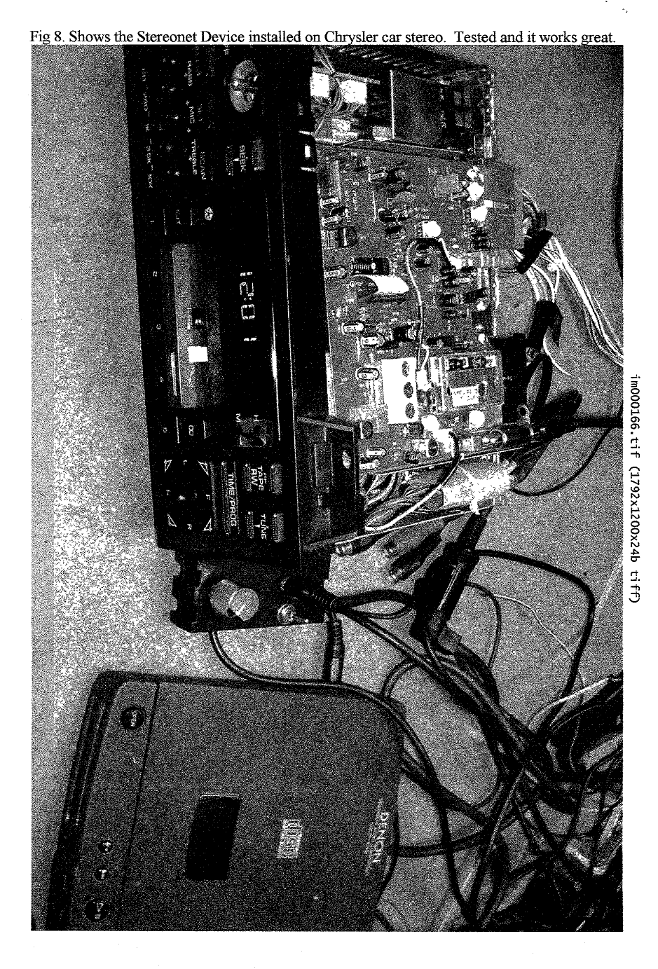

8. FIG. 8, shows the Stereonet Device installed on Chrysler car stereo. Tested and it works great.

### DETAILED DESCRIPTION

The Detailed Description contains 3 pages. Each page has detailed descriptions of each drawing.

A. This first page of the Detailed Description described the Block Diagram on the first sheet of the drawings and shows the brief description in detail of the second and third drawings, and shows how the Stereonet Device works.

i. External source of the audio signal can go into the 3.5 mm stereo input jack, and input a signal to an isolator/unity gain amplifier for converting low current output impedance from variety stereo products, to voltage output impedance and send it to the 2^{nd} stage switching circuit.

ii. The clip microphone picks up the audio voice sounds from the cellular phone, and inputs its dynamic audio signal into the microphone amplifier, then amplifies the signal and balance it with the signal from the 3.5 mm stereo input jack in case the user using the fixed standard pre-amp output stereo product doesn't have volume signal level control. It also converts impedance balance of the microphone, and then sends a signal to the 2^{nd} stage switching circuit.

iii. The 2^{nd} stage switching circuit will switch audio signals between the microphone and the 3.5 mm stereo jack, upon the selection of S1, then sends the audio signal to the volume control block.

iv. The volume control VR1 on this device uses a single shaft dual resistor element unit with an on/off switch. The volume control selects the audio volume level of the Stereonet Device independently from the user's stereo. The audio signal is sent to the 1^{st} stage switching circuit via din cable and connectors. The switch is used to enable the 1^{st} stage switching circuit, which selects the audio signal from the Stereonet Device when the volume control switch is turned on.

v. The 1^{st} stage switching circuit will switch the audio signals between the user's stereo and audio signal from the 2^{nd} stage switching circuit of the Stereonet Device, upon the selection of switch on volume control in the 2^{nd} P. C. Board. It will select and switch the audio signal from Stereonet Device when turned on, and vice versa, then output the signal to the 4 channels pre-amplifiers to compensate the signal lost from the switching circuit, then output to the user's power amp section by color-coded wires.

vi. The add-on external pre-amp output circuit gets an audio signal from the output of the 1^{st} stage switching circuit and amplifies it to standard pre-amp signal output levels and sends the signal out to the RCA cable connector.

vii. The power supply converts the +14 voltage DC to +9 voltage DC for all Stereonet Device circuit uses.

viii. The power consumption of the whole device's circuit is 26.4 milliamps.

B. This second page of the Detailed Description describes the 2^{nd} sheet of the drawing showing the electronic schematics for the 1^{st} stage switching circuit and external pre-amp output circuit.

1. The IC U1 and U2 is the CMOS MC14066B Quad Analog Switching IC consists of four independent bilateral switches and useful in signal gating. The Stereonet Device's 1^{st} stage switching circuit uses two Switching ICs which 8 bilateral switch to gating 4 channels of signals.

2. The connection of the IC shows on the schematics because of its bilateral characteristic, the input and the output can be interchangeable. The user's stereo signal input to pin 4 & 8 of the Switching IC and output through pin 3 and 9 when pin 5 & 6 active high. The audio stereo signal from the 2^{nd} stage switching circuit input to pin 1 & 11 of the Switching IC, and output through pin 2 and 10 when pin 12 & 13 are active high, and vise versa.

3. The transistor Q1 provide the CONTL_A signal, which is inverted with CONT_B, to provide gating condition for both ICs to select either the user's stereo or the audio stereo signal from the 2^{nd} stage switching circuit. The CONTL_B is active high when the volume control switch is turned off, and it is active low when volume controls switch turn on.

4. The SDin_L, SDin_R, SDB+, CONTL_B, and SDGND connects to Din cable and Jack to provide the connection to the 2^{nd} stage switching circuit of the Stereonet Device.

5. The IN_FL, IN_FR, IN_RL, IN_RR, OUT_FL, OUT_FR, OUT_RL, OUT_RR are the 8 color-coded wires providing signals in and out to user's stereo, and the B+ and Ground 2 wires. These 10 wires are soldered directly to the users stereo's pre-amp section.

6. The Capacitors C1-C10, and C12-C22 are used to block the DC, some of this capacitor may omit or change value depends on the model and brand name of user's stereo.

7. The Op-amp U3A, U3B, U4A and U4B are none invert pre-amplifier circuit; it used to compensate the signal lost by the switching circuits. The reference voltage provides by divider R4 and R5. The U5A, U5B, U6A, and U6B are the none invert pre-amplifier circuit uses to bring up the 4 of external pre-amp output level to standard level, or balance with the output from the user stereo's amp. The gain control resistor R14, R15, R32 and R33 may be vary depending on each user's stereo model and brand name. The R4 and R5 provide the ½ VCC reference voltage for all 8 op-amp pre-amplifiers on this P.C. Board.

8. The Q2, Q3, Q4, Q5, R6, R7, C23, C24, D1, connect to CONTL_B to provide a mute function when the volume control switch is turned on or off to avoid annotations pop noise.

9. The Q6, Q7, ZD1, C26, and R47 use provide +9V power for all Stereonet Device Circuit use.

10. The RCA_FL, RCA_FR, RCA_RL, and RCA_RR are the RCA cable jack connector for the user to add external amplifiers to their stereo systems.

11. The C25, C26 and C27 are the filter capacitors.

C. This third page of the Detailed Description Described the 3^{rd} sheet of the Drawing shows the electronic schematics for the 2^{nd} stage switching circuit and the component around it.

a. The J1 is a 3.5 mm stereo input phone jack, to let the user input the external audio signal from variety of the stereo product. C116 is a signal ground isolator to avoid the signal ground noise.

b. The op-amp IC U101A and U101B circuit is a unity gain amplifier to prevent signal loss from diffident impedance, and uses to converting the impedance of variety source audio signal, from a variety of the stereo product. It is low output impedance current-to-voltage output converter. The Audio signal output to Pin 1 & 7, and send to the 2^{nd} stage switching IC U103 Pin 4 & 8.

c. The Capacitor C101-C108 are used to block the DC.

d. The Microphone Mic1 collects the voice audio sound from the cellular phone, convert it to audio signal and send it to U102B. The R103 is the load for the MIC1

e. The IC U102B and C105, C110, C111, C112, R106, R107, and R108, are the notch filter uses to prevent the 2.8 KHz echo noise.

f. The op-amp IC U102A amplified the microphone audio signal and VR2 used to balance it with external audio signal from J1, with the value determine by R104 and R105, and send it to the 2^{nd} stage switching IC U103 Pin 1 & 11.

g. The R113 and R114 are to provide ½ VCC reference voltage for IC 101, IC 102.

h. The limit resistor R110 uses to prevent too low or no cell phone output signal.

i. The Switching IC 103 circuits, Q101 and Switch S1 are the same as the 1^{st} stage switching circuit that I did previously describe on page 2. It switches the audio signal between the external audio signal and microphone audio signal, upon the on/off select on switch S1 , and output to the volume control VR1_I and VR1_{—}2.

j. The Q102, Q103, R118, R119, C114, C115, D101, connect to CONTL1_A to provide a mute function when the switch S1 is turned on or off to avoid annotations pop noise.

k. The volume control is a single turn single shaft dual resistant element with on/off switch potentiometer. It provides the audio signal level to OUT_L and OUT_R by the position of the volume control potentiometer that the user turned.

l. The Switch on the volume control potentiometer VR1_SW is to provide the switch selections of the 1^{st} stage switching circuit.

m. The terminal B+, CONTL_B, SGND, OUT_L, and OUT_R are to connect to the Din cable connector to provide the connection to the 1^{st} stage switching circuit.

n. The C109 and C119 is the filter Capacitors.

I claim:

1. The switching device consists of two switching circuits, that combines the 3 switching IC's with the components surrounding it, to become a device that can switch the audio signal between an external source audio signal and a microphone signal from a cell phone, and the signal from the user's stereo. The device can switch either 2 channels or switch all 4 channels.

2. The apparatus of claim 1, that the user input of their stereo audio signal through switching device and output it directly by wires soldered to the user's stereo.

3. The apparatus of this invention uses transistors Q1, Q101, switches S1, and VR1_SW to control and switches the switching ICs in the 1^{st} stage switching circuit and the 2nd stage switching circuit.

4. The apparatus of this invention placed a potentiometer in between the 2^{nd} switching circuit and the 1^{st} switching circuit, to control the audio signal volume level of this switching device.

5. The apparatus of claim 1, uses two switching ICs, U1 and U2, which the total of 8 bilateral switches to gating of 2 or 4 channel of audio signals from the user's stereo. Gating 2 channels or multiplex to 4 channels of audio signals from 2^{nd} switch circuit of this switching device to the user's stereo, and using another 1 switching IC U103, which quad bilateral switches to gating the external source audio signal and a microphone signal pick-up from a cell phone.

6. The apparatus of this invention uses transistors Q2, Q3, Q4, Q5, Q102, Q103 Diode D1, D101 resistors R6, R7, R118, R119 and capacitors C20, C21, C114, C115 to provide the mute function for this switching device when VR1_SW or S1 is flipped on/off by the user

7. The apparatus of this invention uses the capacitors C1-C10, C12-C22, and C101-C108 to block the DC.

8. The apparatus of this invention uses 3.5 mm stereo phone jack J1, capacitor C116, and Op-amp IC U101 to input the external source audio stereo signal from a variety of stereo products, and balance its impedance, and then output it to the switch IC.

9. The apparatus of claim 8, that capacitor C116 uses to isolate the signal ground with the external stereo to prevent the signal ground noise.

10. The apparatus of this invention use Microphone Mic1, Op-amp IC U102A and U102B, Potentiometer VR2, Resistors R103, R104, R105, R106, R107, R108, R109, R110, R111, R120, R121 and VR2, Capacitor C105, C110, C111, and C112 for car driver hands free talking on cell phone product.

11. The apparatus of claim 10, that the microphone Mic1 to pick up the human voice sound/dynamic audio from the cellular phone, converting it into an analog audio signal.

12. The apparatus of claim 10, that the Op-amp IC U102A to amplify the microphone audio signals picks up from cell phone, and the VR2 uses to balances its signal level with the external source audio stereo signal from J1 and U101.

13. The apparatus of claim 10, that the Op-amp U102B, C105, C110, C111, C112, R104, R105, R106, R107, and R108 are the notch filter circuit uses to prevent echo noise.

14. The apparatus of claim 10, that the R121 is for noise cancellation, and R110 to prevent low/no microphone signal output.

15. The apparatus of this invention uses the voltage divider circuit resistors R4, R5 and R113, R114 to provide ½ VCC/B+ reference voltage for Op-Amp ICs.

16. The apparatus of this invention uses Din cable and jack and connector to connect the 2^{nd} switching circuit to the 1^{st} switching circuit.

17. The apparatus of this invention uses Op-amp ICs U3 and U4 to amplify the signal to compensate the signal lost by the switching IC circuits.

18. The apparatus of this invention uses Op-amp ICs U5 and U6 to amplify the signal from the output of the 1^{st} switching circuit up to the standard pre-amp output level for external pre-amp output.

19. The apparatus of this invention uses transistor Q6, Q7, zener diode ZD1, resistor R47, and capacitor C26 to convert the +14V to +9V for this switching device uses.

20. The apparatus of this invention uses RCA cable jack connectors to provide pre-amp output.
